(19) United States
(12) Patent Application Publication
(10) Pub. No.: US 2014/0277646 A1
(43) Pub. Date: Sep. 18, 2014

(54) TECHNIQUE FOR AUGMENTING THE ACOUSTIC OUTPUT OF A PORTABLE AUDIO DEVICE

(71) Applicant: LOGITECH EUROPE S.A., Morges (CH)

(72) Inventors: Jeff ANDERSON, Camas, WA (US); Neil O'CONNELL, Portland, OR (US); Stephen LEIGH, Vancouver, WA (US)

(73) Assignee: LOGITECH EUROPE S.A., Morges (CH)

(21) Appl. No.: 13/887,921

(22) Filed: May 6, 2013

Related U.S. Application Data
(63) Continuation of application No. 13/835,507, filed on Mar. 15, 2013.

(51) Int. Cl. G06F 3/16

(52) U.S. Cl. CPC G06F 3/165
USPC 700/94

(57) ABSTRACT

A portable audio device is configured to generate acoustic output in conjunction with an auxiliary audio device when the portable audio device and the auxiliary audio device both reside within a given boundary. When the portable audio device enters a region defined by the boundary, the portable audio device determines optimized device settings and/or parameters for the portable audio device and for the auxiliary audio device based on differences between the operational capabilities of those two audio devices. When the portable audio device exits the region defined by the boundary, the portable audio device returns to nominal operation.

### CROSS-REFERENCE TO RELATED APPLICATIONS

This application claims priority to U.S. patent application Ser. No. 13/835,507, filed Mar. 15, 2013, entitled “Technique For Augmenting The Acoustic Output Of A Portable Audio Device,” which is herein incorporated by reference.

### BACKGROUND OF THE INVENTION

1. Field of the Invention

The present invention generally relates to audio devices and, more specifically, to a technique for altering the acoustic output of an audio device that is used in conjunction with one or more other audio devices.

2. Description of the Related Art

The popularity of portable music players has increased dramatically in the past decade. Modern portable music players allow music enthusiasts to listen to music in a wide variety of different environments without requiring access to a wired power source. For example, a battery-operated portable music player such as an iPod® is capable of playing music in a wide variety of locations without needing to be plugged in.

Conventional portable music players are typically designed to have a small form factor in order to increase portability. Accordingly, the batteries within such music players are usually small and only provide several hours of battery life. Similarly, the speakers within such music players are typically small and mono-aural, and usually designed to consume minimal battery power in order to extend that battery life.

As a result, the speakers within conventional portable music players oftentimes have a dynamic range covering only a fraction of the frequency spectrum associated with most modern music. For example, modern music often includes a wide range of bass frequencies. However, the speakers within a conventional portable music player usually cannot play all of the bass frequencies due to physical limitations of the speakers themselves, or because doing so would quickly drain the batteries within the music player.

Consequently, the sound quality of music played by conventional portable music players is almost universally low. Moreover, since conventional portable music players have a small form factor, providing stereo sound without earphones is generally impossible, further reducing the sound quality that is possible with such music players.

As the foregoing illustrates, what is needed in the art is an improved portable music player that is able to provide an improved sound quality and an extended battery life.

### SUMMARY OF THE INVENTION

One embodiment of the invention includes a computer-implemented method for causing a first audio device to generate acoustic output in conjunction with a second audio device, including determining that the first audio device and the second audio device both reside within a boundary, retrieving device specifications associated with the second audio device that reflect the operational capabilities of the second audio device, causing the first audio device to generate a first acoustic output based on the device specifications associated with the second audio device, and causing the second audio device to generate a second acoustic output based on the device specifications associated with the second audio device, wherein the first acoustic output and the second acoustic output are both derived from audio data, and wherein the first acoustic output includes one or more different frequencies not included within the second acoustic output.

Embodiments of the invention may further provide a non-transitory computer-readable medium storing program instructions that, when executed by a processing unit, cause the processing unit to coordinate a first audio device in generating acoustic output in conjunction with a second audio device by performing the following steps. First, determining that the first audio device and the second audio device both reside within a boundary. Second, retrieving device specifications associated with the second audio device that reflect the operational capabilities of the second audio device. Third, generating a first acoustic output from the first audio device based on the device specifications associated with the second audio device. Fourth, causing the second audio device to generate a second acoustic output based on the device specifications associated with the second audio device, wherein the first acoustic output and the second acoustic output are both derived from audio data, and wherein the first acoustic output includes one or more different frequencies not included within the second acoustic output.

Embodiments of the invention may further provide an audio device configured to generate acoustic output in conjunction with an auxiliary audio device, comprising a processing unit configured to determine that the audio device and the auxiliary audio device both reside within a boundary, retrieve device specifications associated with the auxiliary audio device that reflect the operational capabilities of the auxiliary audio device, cause the audio device to generate a first acoustic output based on the device specifications associated with the auxiliary audio device, and cause the auxiliary audio device to generate a second acoustic output based on the device specifications associated with the auxiliary audio device, wherein the first acoustic output and the second acoustic output are both derived from audio data, and wherein the first acoustic output includes one or more different frequencies not included within the second acoustic output. The audio device may further comprise a memory unit coupled to the processing unit, wherein the memory unit has information relating to the device specifications of the audio device and/or device specifications of the auxiliary audio device stored therein.

Embodiments of the invention may further provide a computer-implemented method for causing a first audio device to generate acoustic output in conjunction with a second audio device, wherein the method may include the following steps. First, retrieving first device specifications associated with the first audio device that reflects the operational capabilities of the first audio device, and retrieving second device specifications associated with the second audio device that reflects the operational capabilities of the second audio device. Receiving audio data, wherein the audio data is received by the first audio device and when output by the first audio device provides a nominal acoustic output. Then, reducing a power level consumed by the first audio device by delivering a first acoustic output that is based on the received audio data and a comparison of the second device specifications to the first device specifications, wherein the first acoustic output does not include data delivered at one or more frequencies found in the nominal acoustic output.

Advantageously, a portable audio device may provide a richer acoustic experience for the user by augmenting or extending the acoustic output of the portable audio device via the additional operational capabilities of an auxiliary audio device. In addition, the portable audio device may conserve power and extend battery life by reducing the power required to generate frequencies for which the auxiliary audio device may be configured to generate.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a conceptual diagram that illustrates a portable audio device and an auxiliary audio device, according to one embodiment of the present invention;

FIG. 2 is a conceptual diagram that illustrates the portable audio device and auxiliary audio device of FIG. 1 coupled together via a communication link, according to one embodiment of the present invention;

FIG. 3 is a flow diagram of method steps for causing the portable audio device and the auxiliary audio device shown in FIGS. 1-2 to operate in conjunction with one another, according to one embodiment of the present invention; and

FIG. 4 is a flow diagram of method steps for causing the portable audio device and the auxiliary audio device shown in FIGS. 1-2 to stop operating in conjunction with one another, according to one embodiment of the present invention.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

FIG. 1 is a conceptual diagram that illustrates a portable audio device 102. As shown, portable audio device 102 is configured to generate an acoustic output 116 and resides adjacent to a boundary 120 that includes an auxiliary computing device 122.

Portable audio device 102 may be any technically feasible computing device configured to generate an acoustic output. For example, portable audio device 102 could be a cell phone, a tablet computer, or a portable speaker, among other such devices. In practice, portable audio device 102 may be battery-operated, although wired portable audio devices also fall within the scope of the present invention. In one embodiment, portable audio device 102 may be a Logitech SqueezeBox®.

Portable audio device 102 includes a processing unit 104 coupled to input/output (I/O) devices 106 and to a memory unit 108. Memory unit 108 includes a software application 110, audio data 112, and a primary device profile 114. Processing unit 104 may be any hardware unit or combination of hardware units capable of executing software applications and processing data, including, e.g., audio data. For example, processing unit 104 could be a central processing unit (CPU), a digital signal processor (DSP), an application-specific integrated circuit (ASIC), a combination of such units, and so forth. Processing unit 104 is configured to execute software application 110, process audio data 112, and access primary device profile 114, each included within memory unit 108, as discussed in greater detail below.

I/O devices 106 are also coupled to memory unit 108 and may include devices capable of receiving input and/or devices capable of providing output. For example, I/O devices 106 could include one or more speakers configured to generate an acoustic output. Alternatively, I/O devices 106 could include one or more audio ports configured to output an audio signal to an external speaker coupled to the audio ports and configured to generate an acoustic output based on that audio signal. I/O devices 106 may also include one or more transceivers configured to establish one or more different types of wireless communication links with other transceivers residing within other computing devices. A given transceiver within I/O devices 106 could establish, for example, a Wi-Fi communication link or a Bluetooth® communication link, among other types of communication links.

Memory unit 108 may be any technically feasible type of hardware unit configured to store data. For example, memory unit 108 could be a hard disk, a random access memory (RAM) module, a flash memory unit, or a combination of different hardware units configured to store data. Software application 110 within memory unit 108 includes program code that may be executed by processing unit 104 in order to perform various functionalities associated with portable audio device 102. Those functionalities may include configuring portable audio device 102 based on primary device profile 114, and generating audio signals based on audio data 112 and/or primary device profile 114, as described in greater detail herein and below in conjunction with FIG. 2.

Audio data 112 may be any type of data that represents an acoustic signal, or any type of data from which an acoustic signal may be derived. For example, audio data 112 could be an N-bit audio sample, at least a portion of an mp3 file, a WAV file, a waveform, and so forth. In one embodiment, audio data 112 is derived from a cloud-based source, such as Pandora® Internet Radio. As mentioned above, software application 110 may generate audio signals based on audio data 112. Portable audio device 102 may then generate an acoustic output, such as, e.g., primary acoustic output 116, based on those audio signals.

Primary device profile 114 may reflect various settings and/or parameters associated with the acoustic output of portable audio device 102. For example, primary device profile 114 could include equalization settings, volume settings, sound modulation settings, a low-frequency cutoff parameter, a crossover cutoff parameter, and so forth. As mentioned above, software application 110 may configure portable audio device 102 based on primary device profile 114. Portable audio device 102 may then generate an acoustic output, such as, e.g., primary acoustic output 116, based on audio data 112 and based on primary device profile 114, as also mentioned above.

In FIG. 1, portable audio device resides adjacent to boundary 120 that includes an auxiliary audio device 112, as previously mentioned. Boundary 120 may represent any physical or virtual construct that distinguishes one region of physical space from another region of physical space. For example, boundary 120 could be a wall that separates one room of a residence from another room of that residence. Alternatively, boundary 120 could be a virtual threshold represented by data that includes real-world coordinates corresponding to a physical location. In FIG. 1, portable audio device 102 resides external to boundary 120, while auxiliary audio device 122 resides within boundary 120. In one configuration, the boundary 120 is defined by the physical range of the communication link 240 formed between the portable audio device 102 and the auxiliary audio device 122, which is discussed further below in conjunction with FIG. 2.

Auxiliary audio device 122 may be any technically feasible computing device configured to generate an acoustic output. For example, auxiliary audio device 122 could be a subwoofer, a stereo system, a surround-sound system, or a collection of speakers, among other such devices. In practice, auxiliary audio device 122 may be wired and draw power from a wall socket, although battery-operated auxiliary audio devices also fall within the scope of the present invention. In one embodiment, portable audio device 102 may be a Logitech AirPlay®.

Auxiliary audio device 122 includes a processing unit 124 coupled to I/O devices 126 and to a memory unit 128 that includes a software application 130. Processing unit 124 may be any hardware unit or combination of hardware units capable of executing software applications and processing data, including, e.g., audio data. For example, processing unit 124 could be a DSP, CPU, ASIC, a combination of such units, and so forth. In one embodiment, processing unit 124 may be substantially similar to processing unit 104 within portable audio device 102. Processing unit 124 is configured to execute software application 130, as described in greater detail below.

I/O devices 126 are also coupled to memory unit 128 and may include devices capable of receiving input and/or devices capable of providing output. For example, I/O devices 126 could include one or more speakers and/or one or more audio ports configured to output an audio signal to an external speaker. I/O devices 126 may also include one or more transceivers configured to establish one or more different types of wireless communication links with other transceivers, including, e.g. Wi-Fi communication links or Bluetooth® communication links, among others. In one embodiment, I/O devices 216 may be substantially similar to I/O devices 106 within portable audio device 102.

Memory unit 128 may be any technically feasible type of hardware unit configured to store data, including, e.g., a hard disk, a RAM module, a flash memory unit, or a combination of different hardware units configured to store data. In one embodiment, memory unit 128 is substantially similar to memory unit 108 within portable audio device 102. Software application 130 within memory unit 128 includes program code that may be executed by processing unit 124 in order to perform various functionalities associated with auxiliary audio device 122. Those functionalities are described in greater detail below in conjunction with FIG. 2.

FIG. 2 is a conceptual diagram that illustrates portable audio device 102 and auxiliary audio device 122 of FIG. 1 coupled together via communication link 240, according to one embodiment of the invention. As shown, portable audio device 102 and auxiliary audio device 122 both reside within boundary 120. Portable audio device 102 is configured to generate secondary acoustic output 216, and auxiliary audio device 122 is configured to generate auxiliary acoustic output 236. As also shown, memory unit 108 within portable audio device 102 includes secondary device profile 214, and memory unit 128 within auxiliary audio device 122 includes audio data 232 and auxiliary device profile 234.

Portable audio device 102 is configured to determine when portable audio device 102 and auxiliary audio device 122 both reside within boundary 120, and, in response, to establish communication link 240. Portable audio device 102 may implement any technically feasible approach for determining that portable audio device 102 and auxiliary audio device 122 both reside within boundary 120. In one embodiment, portable audio device 102 periodically exchanges data signals with auxiliary audio device 122 and generates a received signal strength indication (RSSI) metric by analyzing the strength of signals received from auxiliary audio device 122. Portable audio device 102 may then determine whether portable audio device 102 and auxiliary audio device 122 both reside within boundary 120 based on the generated RSSI metric.

In a further embodiment, portable audio device 102 may determine whether portable audio device 102 and auxiliary audio device 122 both reside within boundary 120 by determining that the generated RSSI metric exceeds an expected RSSI metric. Portable audio device 102 may also perform a calibration routine with auxiliary audio device 122 in order to determine the expected RSSI metric. Portable audio device 102 could, for example, receive input from a user of portable audio device 102 indicating that portable audio device 102 has crossed boundary 120. Portable audio device 102 could compute the current RSSI metric based on the data signals exchanged with auxiliary audio device 122, and then update the expected RSSI metric to reflect the computed RSSI metric. In general, portable audio device 102 may be configured to compute the RSSI metric based on any type of signal received from auxiliary audio device 122, such as a low-frequency pulse, infrared (IR) beam, acoustic signal, and so forth. Portable audio device 102 may also be configured to implement the above techniques in order to determine that portable audio device 102 and auxiliary audio device 122 no longer reside within boundary 120. With the approaches discussed above, portable audio device 102 may determine, for example, that portable audio device 102 and auxiliary audio device 122 both reside within the same room and are not separated from one another by walls or other physical obstacles.

In another embodiment of the present invention, portable audio device 102 may determine that portable audio device 102 and auxiliary audio device 122 both reside within boundary 120 based on physical communication between the two audio devices. For example, a user of portable audio device 102 could “tap” portable audio device 102 on the surface of auxiliary audio device 122. Based on accelerometer readings generated by portable audio device 102 and/or auxiliary audio device 122 in response to such a “tap,” portable audio device 102 may determine that those two audio devices both reside within boundary 120. Auxiliary audio device 122 may also act as a dock for portable audio device 102, and portable audio device 102 may determine that portable audio device 102 and auxiliary audio device 122 both reside within boundary 120 when portable audio device 102 is docked to auxiliary audio device 122.

In other embodiments of the present invention, portable audio device 102 may determine that portable audio device 102 and auxiliary audio device 122 both reside within boundary 120 when the user of portable audio device 102 indicates that those two audio devices both reside within boundary 120. For example, the user of portable audio device 102 could press a button on portable audio device 102 in order to indicate that portable audio device 102 and auxiliary audio device 122 both reside within boundary 120. Alternatively, the user could perform a gesture that would be measured by accelerometers within portable audio device 102 and identified by portable audio device 102 as indicating that portable audio device 102 and auxiliary audio device 122 both reside within boundary 120.

Persons skilled in the art will recognize that a wide variety of techniques may be implement by portable audio device 102 and/or auxiliary audio device 122 in order to determine that portable audio device 102 and auxiliary audio device 122 both reside within boundary 120. Likewise, persons skilled in the art will recognize that portable audio device 102 may implement any of the aforementioned techniques in order to determine that portable audio device 102 and auxiliary audio device 122 no longer both reside within boundary 120. In one embodiment, auxiliary audio device 122 may perform any of the techniques discussed above relative to portable audio device 102 in order to determine that portable audio device 102 and auxiliary audio device 122 both reside within boundary 120 (or, conversely, do not both reside within boundary 120). Further, persons skilled in the art will recognize that the aforementioned approaches are exemplary in nature and not meant to limit to scope of the present invention described herein.

Once portable audio device 102 determines that portable audio device 102 and auxiliary audio device 122 both reside within boundary 120, portable audio device 102 establishes communication link 240 with auxiliary audio device 122, as mentioned above. Communication link 240 may be any technically feasible data pathway capable of transporting data, including, e.g., a Wi-Fi link or a Bluetooth® link, a physical data link, analog link, and so forth. Portable audio device 102 may establish communication link 240 by performing a manual or automatic pairing procedure with auxiliary audio device 122 or otherwise exchanging communication protocol information.

Portable audio device 102 may then acquire device specifications (not shown) from auxiliary audio device 122 that reflect the operational capabilities associated with audio device 122. The device specifications associated with auxiliary audio device 122 could represent, for example, a dynamic range, a power output, a number of speakers, a position of speakers, a battery level, a volume range, or a default equalization setting of auxiliary audio device 122, among others. In one embodiment, the device specifications may indicate a device identifier associated with auxiliary audio device 122, and portable audio device 102 may be configured to retrieve additional device information associated with auxiliary audio device 122 using that device identifier (e.g., via a cloud-based service). Portable audio device 102 is configured to analyze those device specifications and to then cause portable audio device 102 and auxiliary audio device 122 to generate secondary acoustic output 216 and auxiliary acoustic output 236, respectively, in conjunction with one another.

Secondary acoustic output 216 and auxiliary acoustic output 236 may both be derived from audio data 112, however, those acoustic outputs may generally include different frequencies. For example, secondary acoustic output 216 could include non-bass frequencies, while auxiliary acoustic output 236 could include bass frequencies. Portable audio device 102 is configured to analyze the device specifications associated with auxiliary audio device 122 and to determine which frequencies auxiliary audio device 122 is optimally suited to generate relative to portable audio device 102. Portable audio device 102 may then cause auxiliary audio device 122 to generate acoustic output 236 having those frequencies for which auxiliary audio device 122 is optimally suited to generate. For example, when auxiliary audio device 122 is a subwoofer audio device, portable audio device 102 could acquire device specifications from auxiliary audio device 122 indicating that auxiliary audio device 122 is capable of generating a wide range of bass frequencies. Portable audio device 102 could then cause auxiliary audio device 122 to generate acoustic output 236 with the corresponding range of bass frequencies.

Portable audio device 102 may then generate acoustic output 216 with reduced power dedicated to generating the frequencies for which auxiliary audio device 122 is optimally suited to generate. Returning to the above example, where auxiliary audio device 122 is a subwoofer device, portable audio device 102 may generate acoustic output 216 with reduced power dedicated to generating bass frequencies. Since auxiliary audio device 122 may be optimally suited to generating those bass frequencies, portable audio device 102 may rely on auxiliary audio device 122 for generating those frequencies. With this approach, portable audio device 102 may conserve battery power since portable audio device 102 is no longer required to generate those bass frequencies. In various other embodiments, portable audio device 102 may not reduce power and may simply continue generating acoustic output 116 upon determining that portable audio device 102 and auxiliary audio device 122 both reside within boundary 120.

In general, portable audio device 102 may take advantage of the operational capabilities of auxiliary audio device 122 in order to augment the operational capabilities of portable audio device 102. Portable audio device 102 may also take advantage of the operational capabilities of auxiliary audio device 122 in order to extend the operational capabilities of portable audio device 102. Retuning to the above example yet again, portable audio device 102 may not be able to generate all of the bass frequencies associated with audio data 112. However, portable audio device 102 could cause auxiliary audio device 122 to generate acoustic output 236 having those bass frequencies, thereby providing a richer acoustic experience for the user for the user of portable audio device 102 than possible with portable audio device 102 alone.

Portable audio device 102 may determine the range of frequencies for which auxiliary audio device 122 is optimally suited to generate relative to portable audio device 102 by comparing device specifications associated with auxiliary audio device 122 to analogous device specifications associated with portable audio device 102. For example, portable audio device 102 could compare the dynamic range of portable audio device 102 to the dynamic range of auxiliary audio device 122 and then determine specific frequencies that auxiliary audio device 122 may generate more effectively and/or efficiently than portable audio device 102.

Persons skilled in the art will recognize that the approaches described thus far are not limited to audio devices capable of generating acoustic outputs having different frequency ranges, per se. More specifically, portable audio device 102 may implement the approaches described thus far in order to cause auxiliary audio device 122 to generate auxiliary acoustic output 236 as having generally different sound quality compared to secondary acoustic output 216. For example, portable audio device 102 could cause auxiliary audio device 122 to generate acoustic output 236 based on different equalization settings than those implemented by portable audio device 102 when generating acoustic output 216. Alternatively, portable audio device 102 could cause auxiliary audio device 122 to generate acoustic output 236 based on different volume settings than those implemented by portable audio device 102 when generating acoustic output 216. In addition, persons skilled in the art will recognize that the techniques described herein are not limited in application to just two audio devices, and that any number of devices may be configured to generate acoustic output in conjunction with one another by implementing the techniques described herein.

Portable audio device 102 may implement the general approach described above for coordinating the generation of secondary acoustic output 216 and auxiliary acoustic output 236 by implementing a variety of techniques. However, two such techniques, associated with different embodiments of the invention, are described in greater detail below.

In one embodiment, portable audio device 102 may acquire device specifications associated with auxiliary audio device 122 and then generate secondary device profile 214 and auxiliary device profile 234. Portable audio device 102 may store secondary device profile 214 within memory unit 108, while auxiliary audio device 122 may store auxiliary device profile 234 within memory unit 128, as is shown in FIG. 2. In one configuration, the portable audio device 102 transfers the auxiliary device profile 234 to the auxiliary audio device 122 using the communications link 240. Secondary device profile 214 may reflect various settings and/or parameters associated with acoustic output 216 of portable audio device 102. Likewise, auxiliary device profile 234 may reflect various settings and/or parameters associated with acoustic output 236 of auxiliary audio device 122.

Software application 110 within memory unit 108, when executed by processing unit 104, may configure portable audio device 102 based on the settings and/or parameters included within secondary device profile 214. Similarly, software application 130 within memory unit 128, when executed by processing unit 124, may configure auxiliary audio device 122 based on the settings and/or parameters included within auxiliary device profile 234. Portable audio device 102 and auxiliary audio device 122 may then generate secondary acoustic output 216 and auxiliary acoustic output 236, respectively, based on the configurations associated with secondary device profile 214 and auxiliary device profile 234, respectively.

As mentioned above, secondary acoustic output 216 and auxiliary acoustic output 236 may both be derived from audio data 112. Auxiliary audio device 122 may receive audio data 112 from portable audio device 102 from across communication link 240 and store that audio data as audio data 232. The received and stored audio data 232 and auxiliary device profile 234 can then be used by the processing unit 124 to form the auxiliary acoustic output 236. Alternatively, auxiliary audio device 122 may retrieve audio data 232 from a cloud-based source, such as, e.g., Pandora® Internet Radio and alter the output based on the auxiliary device profile 234 to form the auxiliary acoustic output 236. Persons skilled in the art will recognize that audio data may be derived from a wide variety of sources, and that the exemplary sources discussed herein do not limit the scope of the invention. Portable audio device 102 may also coordinate the generation of secondary acoustic output 216 and auxiliary acoustic output 236 through another technique associated with another embodiment of the invention, as described in greater detail below.

In another embodiment, portable audio device 102 may acquire device specifications associated with auxiliary audio device 122 and compare those device specifications to analogous device specifications associated with portable audio device 102, similar to the previous embodiment discussed above. However, portable audio device 102 may then derive modulated audio data from audio data 112 that is optimally suited for the operational capabilities associated with auxiliary audio device 122. In this configuration, the portable audio device 102 is adapted to alter the audio data 112 and transfer the altered audio data to the auxiliary audio device 122 based on the acquired device specifications associated with auxiliary audio device 122, thus providing a desired auxiliary acoustic output 236 from the auxiliary audio device 122. In one example, when auxiliary audio device 122 is a subwoofer audio device, portable audio device 102 may derive modulated audio data from received audio data 112 that includes bass frequencies having higher amplitudes than those present in audio data 112, and then transfer the modulated audio to the auxiliary audio device 122. Auxiliary audio device 122 may store that modulated audio data as audio data 232. With this approach, portable audio device 102 may improve the sound quality created by the auxiliary audio device 122 and the portable audio device 102, without necessarily requiring re-configuration of the auxiliary audio device 122. Portable audio device 102 may still optionally implement secondary device profile 214 in order to re-configure portable audio device 102, however such re-configuration of the auxiliary audio device 122 is not required when implementing this embodiment.

Portable audio device 102 may also be paired with multiple different auxiliary audio devices, including auxiliary audio device 122, and may include a matrix of preconfigured auxiliary device profiles for each pairing of portable audio device 102 with a given auxiliary audio device. When pairing with a particular auxiliary audio device, portable audio device 102 may query the matrix of preconfigured auxiliary device profiles and retrieve a secondary device profile for portable audio device 102 and an auxiliary device profile for the given auxiliary audio device according to that specific pairing. The manufacturer of portable audio device 102 may predetermine the various combinations of secondary device profiles and auxiliary device profiles included within the matrix of preconfigured device profiles and pre-program portable audio device 102 to include that matrix. In one configuration, the memory unit 108 of the audio device 102, which is coupled to the processing unit 104, has information relating to the device specifications of the audio device 102 and/or auxiliary audio device 122 stored therein. The stored information may include the audio device profile, one or more auxiliary device profiles and/or other information that will help facilitate the generation of an improved the sound quality generated by the auxiliary audio device 122 and the portable audio device 102.

In one embodiment, both portable audio device 102 and auxiliary audio device 122 may include a link to the cloud, and may interact with various cloud-based services via that link. For example, portable audio device 102 and/or auxiliary audio device 122 could retrieve audio data, such as audio data 112 and/or audio data 232, from a cloud-based service via the link to the cloud. In a further embodiment, portable audio device 102 may be configured to interact with a cloud-based service that allows a user of portable audio device 102 to manage the various device profiles that may be associated with portable audio device 102 and/or auxiliary audio device 122. The cloud-based service could expose a graphical user interface (GUI) that allows the user to directly control the various settings and/or parameters included within a given device profile associated with portable audio device 102 or auxiliary audio device 122.

In practice, portable audio device 102 and auxiliary audio device 122 may be configured to operate in conjunction with one another “out of the box” and may include device profiles that would enable such co-operation. For example, portable audio device 102 could be configured to include both a primary device profile 114 and a secondary device profile 214 at the time of manufacture, while auxiliary audio device 122 could be configured to include auxiliary audio device profile 234 at the time of manufacture. Upon determining that portable audio device 102 and auxiliary audio device 122 both reside within boundary 120, portable audio device 102 could automatically perform a reconfiguration process and begin generating secondary acoustic output 216 based on secondary device profile 214, while auxiliary audio device 122 could automatically perform a reconfiguration process and begin generating auxiliary acoustic output 236 based on auxiliary device profile 234. Additionally, portable audio device 102 could be preloaded with auxiliary device profile 234 and, upon determining that portable audio device 102 and auxiliary audio device 122 both reside within boundary 120, modulate audio data 112 based on auxiliary device profile 234 and then cause auxiliary audio device 122 to output that modulated audio data.

With this approach, portable audio device 102 may be pre-loaded with one or more specific device profiles for use when generating acoustic output cooperatively with auxiliary audio device 122. Likewise, auxiliary audio device 122 may be pre-loaded with another specific device profile for use when generating acoustic output cooperatively with portable audio device 102. Similar to the other approaches described herein, the preloaded device profiles within portable audio device 102 and auxiliary audio device 122 would make optimal use of the capabilities associated with each of those two devices. In addition, each of portable audio device 102 and auxiliary audio device 122 could be preloaded with multiple different device profiles that could be used with multiple different devices. Once portable audio device 102 has performed the reconfiguration process described above, and auxiliary audio device 122 has also performed an analogous reconfiguration process, portable audio device 102 may stream audio data 112 to auxiliary audio device 122 or may stream modulated audio data to portable audio device 122 based on auxiliary device profile 234, as mentioned above.

By implementing the various approaches described above in conjunction with FIGS. 1-2, portable audio device 102 may be configured to augment or extend the operational capabilities associated with portable audio device 102 by coordinating the generation of acoustic output with auxiliary audio device 122. With these approaches, portable audio device 102 may conserve battery life by relying on auxiliary audio device 122 to output frequencies that require significant power to generate, such as bass frequencies. In addition, portable audio device 102 may enhance the sound quality of music derived from audio data 112 when additional resources, such as auxiliary audio device 122, are available.

FIG. 3 is a flow diagram of method steps for causing portable audio device 102 to operate in conjunction with auxiliary audio device 112, according to one embodiment of the invention. Although the method steps are described in conjunction with the systems of FIG. 1-2, persons skilled in the art will understand that any system configured to perform the method steps, in any order, is within the scope of the present invention.

As shown, a method 300 begins at step 302, where portable audio device 102 generates primary acoustic output based on primary device profile 114. Primary device profile 114 may reflect various settings and/or parameters associated with the acoustic output of portable audio device 102. For example, primary device profile 114 could include equalization settings, volume settings, sound modulation settings, a low-frequency cutoff parameter, a crossover cutoff parameter, and so forth.

At step 304, portable audio device 102 determines that portable audio device 102 and auxiliary audio device 122 both reside within boundary 120. Portable audio device 102 may determine that portable audio device 102 and auxiliary audio device 122 both reside within boundary 120 by implementing a wide variety of techniques, including computing an RSSI metric for signals received from auxiliary audio device 122, detecting low-frequency audio pulses generated by auxiliary audio device 122, detecting an IR pulse generated by auxiliary audio device 122, physically contacting auxiliary audio device 122, or receiving user input indicating that portable audio device 102 and auxiliary audio device 122 both reside within boundary 120. Portable audio device 102 may also perform a calibration routine with auxiliary audio device 122 in order to calibrate any of the aforementioned techniques. That routine may be based on user input indicating whether portable audio device 102 and auxiliary audio device 122 both reside within boundary 120, among other things.

At step 306, portable audio device 102 establishes communication link 240 with auxiliary audio device 122. Communication link 240 may be any technically feasible type of communication link that allows portable audio device 102 and auxiliary audio device 122 to exchange data with one another. For example, communication link 240 could be a wireless link, such as a WiFi link or a Bluetooth® link, or a wired, physical data link or analog link. Portable audio device 102 may also perform a pairing procedure in order to establish communication link 240 with auxiliary audio device 122.

At step 308, portable audio device 102 acquires device specifications associated with auxiliary audio device 122 that reflect the operational capabilities associated with auxiliary audio device 122. The device specifications associated with auxiliary audio device 122 could represent, for example, a dynamic range, a power output, a number of speakers, a position of speakers, a battery level, a volume range, or a default equalization setting of auxiliary audio device 122, among others. In one embodiment, the device specifications may indicate a device identifier associated with auxiliary audio device 122, and portable audio device 102 may be configured to retrieve additional device information associated with auxiliary audio device 122 using that device identifier (e.g., via a cloud-based service).

In practice, portable audio device 102 and auxiliary audio device 122 may also be configured to operate in conjunction with one another “out of the box” and may be preloaded with device profiles that would enable such co-operation. With this approach, portable audio device 102 may not need to acquire device specifications associated with auxiliary audio device 122 at step 308. Portable audio device 102 may be preloaded to include such information at the time of manufacture, and upon performing step 306 discussed above, may simply stream audio data 112 to auxiliary audio device 122 that is modulated to cause that audio device to generate auxiliary acoustic output 236. Alternatively, portable audio device 102 could, upon performing step 306, transmit an auxiliary device profile 234, which is preloaded in memory within portable audio device 102, to auxiliary audio device 122. Portable audio device 102 could then retrieve a corresponding device profile in order to reconfigure portable audio device 102 (i.e. secondary device profile 214), then proceed directly to step 314.

At step 310, portable audio device 102 determines auxiliary device profile 234 for auxiliary audio device 122. Auxiliary device profile 234 may reflect various settings and/or parameters associated with acoustic output 236 of auxiliary audio device 122, such as equalization settings, volume settings, sound modulation settings, and the like. In one embodiment of step 310, the portable audio device 102 transfers the auxiliary device profile 234 to the auxiliary audio device 122 via the communication link 240.

At step 312, portable audio device 102 determines secondary device profile 208 for portable audio device 102 that reflect various settings and/or parameters associated with acoustic output 216 of portable audio device 102.

At step 314, portable audio device 102 causes auxiliary audio device 122 to generate auxiliary acoustic output 236 based on auxiliary device profile 218. Software application 130 within memory unit 128, when executed by processing unit 124 within auxiliary audio device 122, may configure auxiliary audio device 122 based on the settings and/or parameters included within the generated auxiliary device profile 234 formed in step 310. Auxiliary audio device 122 may then generate secondary acoustic output 216 based on the configuration found in the auxiliary device profile 234.

At step 316, portable audio device 102 generates secondary acoustic output 216 based on secondary device profile 214. Software application 110 within memory unit 108, when executed by processing unit 104 within portable audio device 102, may configure portable audio device 102 based on the settings and/or parameters included within secondary device profile 214. Portable audio device 102 may then generate secondary acoustic output 216 based on the configuration of found in the secondary device profile 214. In this example, the secondary acoustic output 216 is different than the original primary acoustic output 116 (e.g., nominal acoustic output) that would have been delivered by the portable audio device 102 if the method 300 was not performed. Portable audio device 102 may also terminate generation of acoustic output 116 when performing step 316. The method then ends.

By implementing the method 300, portable audio device 102 is configured to rely on auxiliary audio device 122 for the generation and output of certain frequencies associated with audio data 112, thereby balancing the output of different frequencies between portable audio device 102 and auxiliary audio device 122. In one example, prior performing the method 300, the original primary acoustic output 116 provided by the portable audio device 102 includes acoustic information provided over frequencies between about 90 hertz (Hz) and about 20 KHz, and the original primary acoustic output provided by the auxiliary audio device 122 includes acoustic information provided over frequencies between about 40 hertz (Hz) and about 150 Hz. However, after performing method 300 the secondary acoustic output 216 includes acoustic information provided over frequencies between about 120 hertz (Hz) and about 20 KHz, and/or the auxiliary acoustic output 236 includes acoustic information provided over frequencies between about 40 hertz (Hz) and about 120 Hz.

The portable audio device 102 may also return to nominal operation and resume the generation of primary acoustic output 116 when portable audio device 102 and auxiliary audio device 122 no longer both reside within boundary 120, as discussed in greater detail below in conjunction with FIG. 4.

FIG. 4 is a flow diagram of method steps for causing portable audio device 102 and auxiliary audio device 122 to stop operating in conjunction with one another, according to one embodiment of the invention. Although the method steps are described in conjunction with the systems of FIG. 1-2, persons skilled in the art will understand that any system configured to perform the method steps, in any order, is within the scope of the present invention.

As shown, a method 400 begins at step 402, where portable audio device 102 determines that portable audio device 102 and auxiliary audio device 122 no longer reside within boundary 120. Portable audio device 102 may perform step 402 by computing an RSSI metric for signals periodically received from auxiliary audio device 122, and determining that the computed RSSI metric falls below an expected RSSI metric. That expected RSSI metric could be calibrated based on user input, as previously discussed in conjunction with FIG. 2. In one embodiment, step 402 may also be performed manually or semi-automatically, thus relying on some amount of user intervention.

At step 404, portable audio device 102 de-establishes communication link 240 with auxiliary audio device 122. Portable audio device 102 could, for example, terminate pairing between portable audio device 102 and auxiliary audio device 122. At step 406, portable audio device 102 causes auxiliary audio device 122 to terminate the generation of auxiliary acoustic output 236.

At step 408, the portable audio device 102 resumes generation of primary acoustic output 116 based on primary device profile 114. Portable audio device 102 may also terminate generation of secondary acoustic output 216 when performing step 408. The method 400 then ends.

By implementing the method 400, in conjunction with implementing the method 300, portable audio device 102 may seamlessly initiate and terminate the cooperative generation of acoustic output with auxiliary audio device 122. Accordingly, portable audio device 102 is provided with extended battery life as a result of relying on auxiliary audio device 122 for the generation of power-consuming frequencies, while simultaneously providing the user of portable audio device 102 with an enhanced acoustic experience.

Persons skilled in the art will recognize that any of the aforementioned techniques may be implemented by either portable audio device 102 or auxiliary audio device 122, or portable audio device 102 and auxiliary audio device 122 operating in conjunction with one another. For example, auxiliary audio device 122 may be configured to determine whether auxiliary audio device 122 and portable audio device 102 both reside within boundary 120 or both no longer reside within boundary 120. Likewise, auxiliary audio device 122 may be configured to generate secondary audio device profile 214 and to cause portable audio device 102 to generate secondary acoustic output 216 via techniques analogous to those described above in conjunction with FIGS. 1-4. In various other embodiments, auxiliary device 122 may implement the steps found in method 300 and/or the method 400 relative to portable audio device 102, and thus the roles of each device in these methods are reversed.

In sum, a portable audio device is configured to generate acoustic output in conjunction with an auxiliary audio device when the portable audio device and the auxiliary audio device both reside within a given boundary. When the portable audio device enters a region defined by the boundary, the portable audio device determines optimized device settings and/or parameters for the portable audio device and for the auxiliary audio device based on differences between the operational capabilities of those two audio devices. When the portable audio device exits the region defined by the boundary, the portable audio device returns to nominal operation.

Advantageously, the portable audio device may provide a richer acoustic experience for the user by augmenting or extending the acoustic output of the portable audio device via the additional operational capabilities of the auxiliary audio device. In addition, the portable audio device may conserve power and extend battery life by reducing the power required to generate frequencies for which the auxiliary audio device may be configured to generate.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

1. A computer-implemented method for causing a first audio device to generate acoustic output in conjunction with a second audio device, the method comprising:
forming a communication link between the first audio device and the second audio device;
retrieving device specifications associated with the second audio device that reflect the operational capabilities of the second audio device;
generating a first acoustic output from the first audio device based on the device specifications associated with the second audio device; and
generating a second acoustic output from the second audio device, wherein the first acoustic output and the second acoustic output are both derived from audio data received by the first audio device and/or the second audio device, and wherein the first acoustic output has a different output power level from the second acoustic output at one or more frequencies.

2. The computer-implemented method of claim 1, wherein the different output power level in the first or second acoustic outputs comprises not providing an output at the one or more frequencies by either the first or the second audio device.

3. The computer-implemented method of claim 1, further comprising:
determining that the first audio device and the second audio device both reside within the boundary before forming the communication link, wherein determining that the first audio device and the second audio device both reside within the boundary comprises:
receiving a signal from the second audio device;
determining a signal strength associated with the signal; and
determining that the signal strength is greater than or equal to an expected signal strength stored by the first audio device.

4. The computer-implemented method of claim 3, wherein the signal received from the second audio device comprises a radio frequency signal, an infrared signal, an audio signal or a vibrational signal.

5. The computer-implemented method of claim 3, wherein the expected signal strength is generated by performing a calibration routine, and performing the calibration routine comprises:
receiving user input indicating that the first audio device and the second audio device both reside within the boundary;
receiving a calibration signal from the second audio device;
determining a signal strength associated with the calibration signal; and
storing the signal strength associated with the calibration signal as the expected signal strength.

6. The computer-implemented method of claim 1, wherein the communication link comprises a Wi-Fi link, a Bluetooth® link, a physical link, or a link via a cloud-based service.

7. The computer-implemented method of claim 1, further comprising:
determining that the first audio device and the second audio device no longer both reside within the boundary;
terminating generation of the first acoustic output; and
causing the second audio device to terminate generation of the second acoustic output.

8. The computer-implemented method of claim 1, further comprising generating a nominal acoustic output from the first audio device prior to generating the first acoustic output, wherein the first acoustic output includes one or more different frequencies not included within the nominal acoustic output.

9. The computer-implemented method of claim 1, further comprising generating a nominal acoustic output from the first audio device prior to generating the first acoustic output, wherein the first acoustic output has a different output power level from the nominal acoustic output at one or more frequencies

10. A computer-implemented method for causing a first audio device to generate acoustic output in conjunction with a second audio device, the method comprising:
forming a communication link between the first audio device and the second audio device;
retrieving device specifications associated with the first audio device that reflect the operational capabilities of the first audio device;
generating a first acoustic output from the first audio device; and
generating a second acoustic output from the second audio device based on the device specifications associated with the first audio device, wherein the first acoustic output and the second acoustic output are both derived from audio data received by the first audio device and/or the second audio device, and wherein the first acoustic output has a different output power level from the second acoustic output at one or more frequencies.

11. The computer-implemented method of claim 10, wherein the different output power level of the first or second acoustic outputs comprises not providing an output at the one or more frequencies by either the first or the second audio device.

12. The computer-implemented method of claim 10, further comprising:
determining that the first audio device and the second audio device both reside within the boundary before forming the communication link, wherein determining that the first audio device and the second audio device both reside within the boundary comprises:
receiving a signal from the second audio device;
determining a signal strength associated with the signal; and
determining that the signal strength is greater than or equal to an expected signal strength stored by the first audio device.

13. The computer-implemented method of claim 10, wherein the communication link comprises a Wi-Fi link, a Bluetooth® link, a physical link, or a link via a cloud-based service.

14. The computer-implemented method of claim 10, further comprising generating a nominal acoustic output from the first audio device prior to generating the first acoustic output, wherein the first acoustic output includes one or more different frequencies not included within the nominal acoustic output.

15. The computer-implemented method of claim 10, further comprising generating a nominal acoustic output from the first audio device prior to generating the first acoustic output, wherein the first acoustic output has a different output power level from the nominal acoustic output at one or more frequencies.

16. A computer-implemented method for causing a first audio device to generate acoustic output in conjunction with a second audio device, the method comprising:
forming a communication link between the first audio device and the second audio device;
retrieving device specifications associated with the second audio device that reflect the operational capabilities of the second audio device;
generating a first acoustic output from the first audio device based on the device specifications associated with the second audio device, wherein the first acoustic output is derived from audio data received by the first audio device;
altering the received audio data based on the retrieved device specifications associated with second audio device;
transfer the altered audio data to the second audio device from the first audio device; and
generating a second acoustic output from the second audio device based on the altered audio data, wherein the first acoustic output and the second acoustic output are different.

17. The computer-implemented method of claim 16, wherein the difference between the first acoustic output and the second acoustic output includes a difference in the power level of the acoustic output at one or more frequencies delivered by the first and the second audio devices.

18. The computer-implemented method of claim 16, further comprising:
determining that the first audio device and the second audio device both reside within the boundary before forming the communication link, wherein determining that the first audio device and the second audio device both reside within the boundary comprises:
receiving a signal from the second audio device;
determining a signal strength associated with the signal; and
determining that the signal strength is greater than or equal to an expected signal strength stored by the first audio device.

19. The computer-implemented method of claim 16, wherein the communication link comprises a Wi-Fi link, a Bluetooth® link, a physical link, or a link via a cloud-based service.

20. The computer-implemented method of claim 16, further comprising generating a nominal acoustic output from the first audio device prior to generating the first acoustic output, wherein the first acoustic output includes one or more different frequencies not included within the nominal acoustic output.
